(19) United States
(12) Patent Application Publication
(10) Pub. No.: US 2007/0287138 A1
(43) Pub. Date: Dec. 13, 2007

(54) Multi-media instructional system

(76) Inventor: Lazelle Denise, Phoenix, AZ (US)

Correspondence Address: ETHAN D. CIVAN, 170 SOMERSET DRIVE, BLUE BELL, PA, 19422, US

(21) Appl. No.: 11/433,846

(22) Filed: May 12, 2006

(51) Int. Cl. G09B 19/00

(52) U.S. Cl. 434/236

(57) ABSTRACT

An experiential tunnel, including at least one wall and a plurality of learning stations.

### FIELD OF THE INVENTION

The present invention relates to teaching.

### BACKGROUND

Law enforcement officers, emergency workers, and other professionals who work with rape victims often lack empathy for victims of violent sexual offenses and other violent crimes. Such professionals are often well able to defend themselves and have difficulty fully appreciating the pain of those who cannot. Moreover, professionals working with crime victims on a daily basis can become hardened to injustice and may react inappropriately to crime victims, even in an insensitive manner, which can cause further distress and emotional injury to crime victims. An instructional system assisting professionals in empathizing with crime victims would therefore be desirable.

Potential crime victims are often unaware of the tactics and typical behavior patterns of criminals, such as rapists. An instructional system illustrating such tactics and typical behavior patterns would therefore be desirable.

The present invention can benefit all citizens, adults and children, as well, and can function as a learning tool for families, for the support of victims of crimes, for educational institutions, such as colleges or universities, and for institutions that counsel victims of crimes (such as department of human services). It can also serve to educate the public regarding signs and symptoms of crime victims and offenders, such as education regarding symptomatic changes of victims of rape, pedophilia, molestation, and incest.

### SUMMARY OF THE INVENTION

An experiential tunnel, including at least one wall and a plurality of learning stations.

### BRIEF DESCRIPTION OF THE DRAWINGS

FIG. 1 is an illustration of a first embodiment of the present invention.

FIG. 2 is an illustration of a second embodiment of the present invention.

FIG. 3 is a plan view of a third embodiment of the present invention.

FIG. 4 is a side view of a third embodiment of the present invention.

FIG. 5 is an interior view of a third embodiment of the present invention.

### DETAILED DESCRIPTION OF THE PREFERRED EMBODIMENTS

The following definitions are provided to aid in construing the claims of the present application:
Experiential Tunnel: A partially or totally enclosed structure, such as, but not limited to, a tunnel or corridor that includes at least one learning station.
Learning Station: An audio, video, visual or other source of information about a subject or experience.

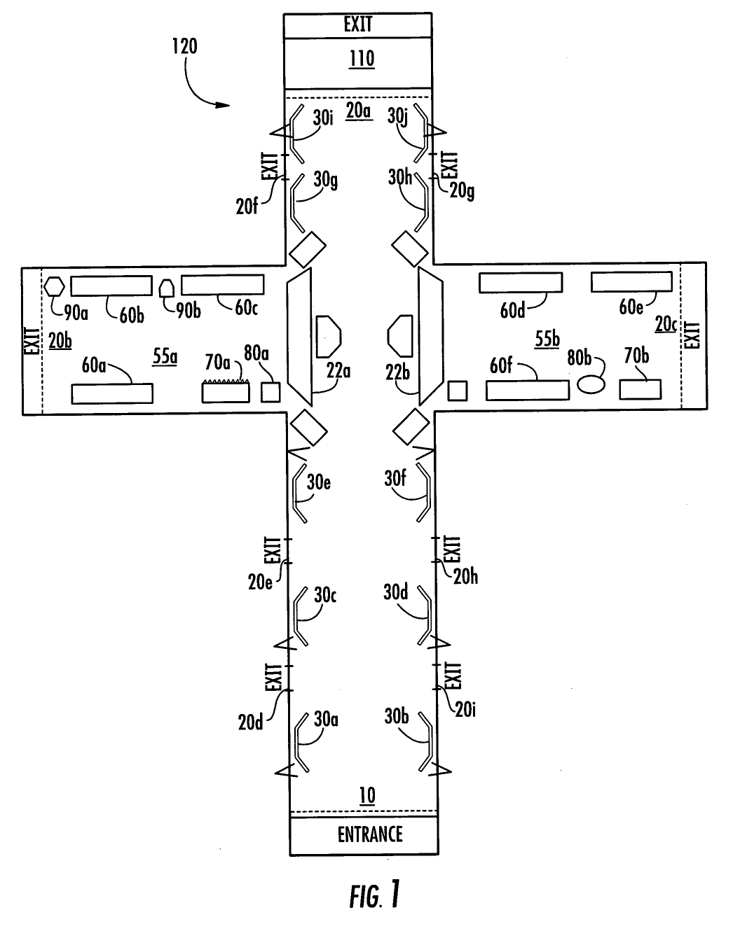

Referring to FIG. 1, in a first preferred embodiment of the present invention, experiential tunnel 120 is a tunnel-shaped chamber in the form of a cross. In other embodiments of the present invention, the experiential tunnel is a straight tunnel without a cross piece or is a completely different shape of tunnel or chamber. Experiential tunnel 120 includes walls 4a through 4h running along the perimeter of the experiential chamber and roof 6 covering the experiential chamber. The walls and roof can be constructed of a wide variety of materials, including wood, stone, plastics, metal, fabric (on a frame of metal, wood, or plastic), or other materials. In a first preferred embodiment, the experiential tunnel is portable. Therefore, it is desirable that the materials be both light and easy to assemble and disassemble. Materials such as aluminum and plastics are therefore desirable.

The size of the experiential tunnel depends on its intended purpose, on the number of learning stations included in it, and on the number of anticipated simultaneous users. In a first preferred embodiment intended for simultaneous use by many users in connection with instruction concerning violent sexual crimes, it is anticipated that experiential tunnel 120 will be at least ten feet wide, seven feet tall, and sixty feet long (down the main tunnel from entrance 10 to the end of praise tunnel 110).

The number of entrances and exits also depends on the anticipated use. Because instruction concerning violent sexual situations, the confined shape of the instructional tunnel, and the dim lighting could become overwhelming to some users, a greater number of exits are present in the first preferred embodiment, with entrance 10 and exits 20a through 20g being illustrated. In addition, doors 22a and 22b provide egress from the instructional area of the experiential tunnel to snack and relaxation areas 55a and 55b, where benches 60a through 60e, refreshments 70a and 70b, trashcans 80a and 80b, and tables 90a through 90d are located.

Along the main tunnel, in a first preferred embodiment, learning stations 30a through 30j, lighting 40a through 40g are interspersed. Near exit 20a are located screens 100a and 100b, which partially obscure the final learning stations and sound sources 50a and 50b. Screens 100a and 100b can be wicker or other screens, or any other material that partially or totally prevents users from seeing beyond the screens without blocking their movement. Lighting 40a through 40g can be any incandescent, fluorescent, or other form of lighting. In a first preferred embodiment, such lighting provides a minimum amount of light sufficient for users to view the learning stations and avoid injuring themselves while moving about the experiential tunnel.

Learning stations 30a through 30j provide instruction regarding violent sexual crimes using visual information (such as posters presenting facts, charts, and photographs), audible information (such as recordings of sounds), and video information (such as video presentations). Learning stations 30a through 30j can be self-activated. For example, by stepping on a pressure plate, by interrupting a laser beam, or by raising the air temperature a user can activate a learning station and commence a video or sound presentation or light up an otherwise dark learning station. Learning stations 30a through 30j can be silent or can include sound, including utilizing loudspeakers and sound information read from a tape, CD, computer memory, or other source of sound information.

In one preferred embodiment, learning stations 30a and 30b relate generally to the behavior and tactics of rapists and child molesters and include a video presentation illustrating such behavior and tactics so as to educate potential victims on how to avoid becoming victims. Learning stations 30c and 30d include a visual presentation of statistics and other facts relating to sexual crimes. Learning stations 30e and 30f include an audio presentation including simulated or actual police radio recordings relating to rapes and other sex and violent crimes, including both police chatter and victim and crime noise, including screams, gunshots, and so forth. Learning stations 30g and 30h relate to healing and spiritual testimony and assist victims in recovering from their experiences.

In another preferred embodiment, learning station 30a provides an introduction to the experiential tunnel, including an explanation of the reason for the experiential tunnel, its purpose, visual ideas, a summary of what people can benefit from using the experiential tunnel, a history relating to the creation of the experiential tunnel, and an explanation of how the use of the experiential tunnel can affect a user. Learning station 30b provides facts about crimes by region, including statistics about sex crimes broken down by gender, race, nationality, culture, nation, state, city, and locality and facts and anecdotes about sex crimes extending across multiple generations. Learning station 30c provides information relating to sexually transmitted diseases, such as AIDS or HIV, including statistics broken down by gender, race, nationality, culture, nation, state, city, and locality.

Learning station 30d provides information, including an audiovisual presentation, relating to teaching the user to identify a pedophile, including identifying the signs and characteristics of a pedophile, and understanding the subjective experience of encountering a pedophile as a potential victim. Learning station 30e provides information, including an audiovisual presentation, relating to teaching the user to identify a rapist, including identifying the signs and characteristics of a rapist, and understanding the subjective experience of encountering a rapist as a potential victim. Learning station 30f provides information, including an audiovisual presentation, relating to teaching the user to identify a child molester, including identifying the signs and characteristics of a child molester, and understanding the subjective experience of encountering a child molester as a potential victim.

Learning stations 30g and 30h provide the testimony of persons who have overcome the experience of being the victim of sexual crimes. This testimony can be audio, video, visual, printed, or in other form. The persons whose testimony is presented preferably includes persons of different cultures and backgrounds and can be broken down by country, crime overcome, age category (e.g., child, teenager, adult, etc.), and by other categories. Learning stations 30g and 30h can be identical; alternatively, the testimony can be divided among the two learning stations.

Learning station 30i concerns healing methods and provides information relating to agencies providing aid to victims of sexual crimes, including counseling agencies, women's groups, religious groups, organizations providing medical assistances, and other agencies and resources. Learning station 30i can include calming music and visual images (including music and visual images of a spiritual nature).

Learning station 30j concerns prevention methods relating to sexual crimes, including rape and child molestation, including methods relating to educating potential victims, family members, and others about methods of avoiding sexual crimes, avoiding increased risk of sexual crimes from suggestive dress, body language, exposure to music, images, and video that is sexually explicit or that advocates sexual violence, providing safety tips (including buddy systems and carpools), and providing comforting advice from survivors of sexual crimes.

In other embodiments, however, a greater or lesser number of learning stations can be utilized, such learning stations can relate to different subjects, such learning stations can utilize different methods of instruction, and such learning stations can be utilized to teach different subjects, depending on the objective of the particular embodiment.

Praise tunnel 110 provides an opportunity for users to listen to uplifting music that has been previously recorded, such as spiritual music of praise or thanksgiving. Praise tunnel 110 allows users to exit experiential tunnel 120 in a positive frame of mind.

In other embodiments of the present invention, some or all of praise tunnel 110, lighting 40a through 40g, sound sources 50a and 50b, and screens 100a and 100b may be omitted or altered or may be present in different quantities. In addition, a different number or type of learning stations 30a through 30h may be present. Furthermore, the instructional purpose of the experiential tunnel can be different in other embodiments of the present invention. For example, the present invention could be adapted for use in dealing with soldiers recovering from the trauma of combat.

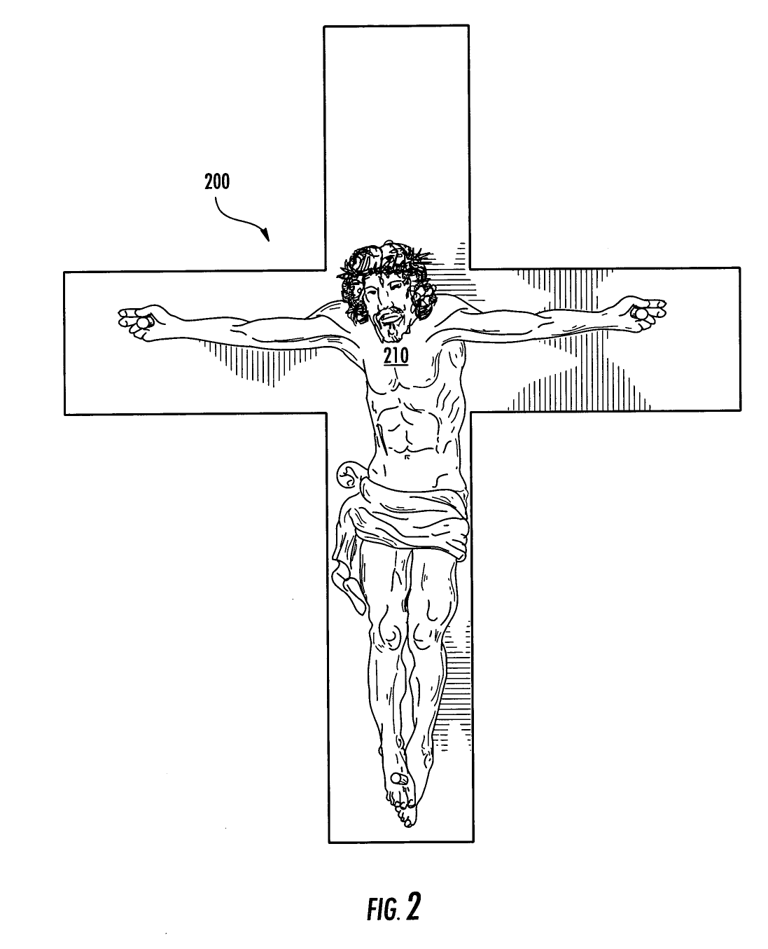

Referring to FIG. 2, a second preferred embodiment of the present invention is illustrated. The interior of the second embodiment is identical to the interior of the first embodiment. The exterior, when viewed from above, however, is in the form of a crucifix, rather than in the form of a simple cross. In a preferred embodiment, the crucifix is realistic in appearance and includes bronzed feet, a blood smeared body, red eyes, nailed hands and feet, a spear in the figure's side, a crown of thorns, woolen hair, and a bruised face. The second embodiment may be created from the first embodiment by painting crucifix 210 on the top of the roof of experiential tunnel 200, by attaching a three dimensional crucifix 210 (such as a sculpture) on the top of experiential tunnel 200), by shining colored lights creating the image of the crucifix on the roof of experiential tunnel 200, or by other means. If a three dimensional crucifix is used, a sufficiently strong structure to support the crucifix is, of course, necessary, which can affect the portability of the experiential tunnel. In some embodiments, the crucifix is also visible from within experiential tunnel 200. For example, an underside view of the crucifix can be displayed by painting the crucifix on the ceiling of experiential tunnel 200 or by shining colored lights on the ceiling of experiential tunnel 200. Preferably, the underside view displays the back of the crucified figure.

In some embodiments of the present invention, the crucifix is removable, allowing experiential tunnel 200 to be utilized in the form of a simple cross at times and in the form of a crucifix at other times. The crucifix can be removed by turning off light sources (if the crucifix is created by shining colored lights on experiential tunnel 200), by detaching a removable canvas, tarpaulin, or other surface on which the crucifix is painted or otherwise located, by covering the crucifix with a blank or otherwise decorated canvas, tarpaulin, or other surface to obscure the crucifix, or by other means.

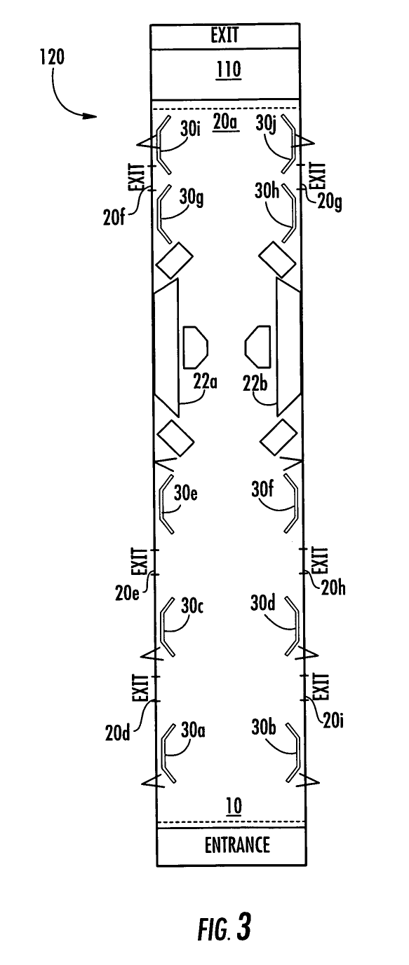

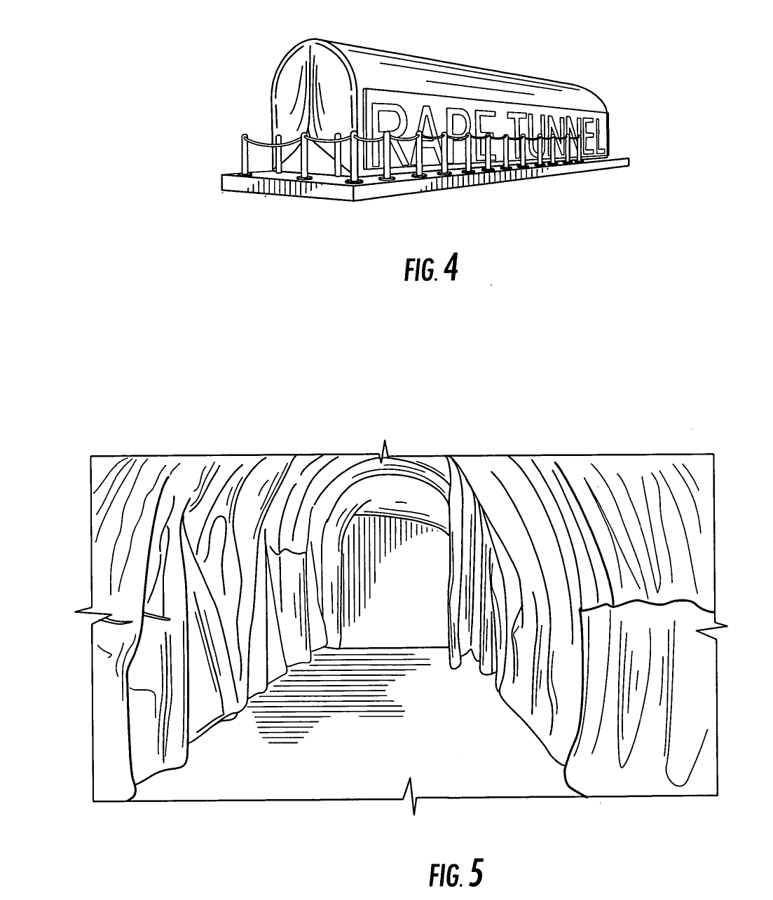

Referring to FIGS. 3 through 5, a third embodiment of the present invention is illustrated. The third embodiment differs from the first embodiment in that the “arms” of the cross are not present; hence, the experiential tunnel is a straight tunnel. Otherwise, entrance 10, exits 20a through 20i, doors 22a and 22b, learning stations 30a through 30j, and praise tunnel 110 are equivalent to the structures present in the first embodiment. FIG. 4 illustrates one possible appearance of the exterior of the experiential tunnel in the third embodiment. FIG. 5 illustrates one possible appearance of the interior of the experiential tunnel in the third embodiment prior to the installation of learning stations, lighting, etc.

The present invention may be embodied in other specific forms without departing from the spirit or essential attributes of the invention. Accordingly, reference should be made to the appended claims, rather than the foregoing specification, as indicating the scope of the invention.

That which is claimed is:

1. An experiential tunnel, comprising:
at least one wall; and
a plurality of learning stations.

2. The experiential tunnel of claim 1, further comprising:
a roof, connected to said at least one wall.

3. The experiential tunnel of claim 2, wherein the experiential tunnel is in the form of a cross when viewed from above.

4. The experiential tunnel of claim 2, wherein the experiential tunnel is in the form of a crucifix when viewed from above.

5. The experiential tunnel of claim 1, wherein said plurality of learning stations include learning stations comprising audiovisual elements that simulate an emotional experience.

6. The experiential tunnel of claim 1, wherein said plurality of learning stations include learning stations comprising audiovisual elements that illustrate behavior and stratagems.

7. The experiential tunnel of claim 1, wherein said plurality of learning stations include learning stations comprising factual information.

8. The experiential tunnel of claim 1, wherein said plurality of learning stations include learning stations comprising music.

9. The experiential tunnel of claim 1, wherein at least one of said plurality of learning stations is automatically activated when it is approached by a user.

10. The experiential tunnel of claim 1, wherein said learning stations comprise a learning station designed to provide a spiritual experience.

11. The experiential tunnel of claim 1, wherein said learning stations comprise a learning station designed to provide an illusory experience.

12. The experiential tunnel of claim 1, wherein the experiential tunnel relates to the prevention and treatment of sex crimes.

13. The experiential tunnel of claim 1, wherein the experiential tunnel relates to rape prevention and treatment.

14. The experiential tunnel of claim 13, wherein said learning stations comprise a learning station relating to rapist behavior and stratagems.

15. The experiential tunnel of claim 13, wherein said learning stations comprise a learning station assisting the user to empathize with rape victims.

16. The experiential tunnel of claim 1, wherein the experiential rape tunnel is portable.

17. The experiential tunnel of claim 1, wherein the experiential rape tunnel is accessible to the disabled.
